(19) United States
(12) Patent Application Publication
(10) Pub. No.: US 2025/0208551 A1
(43) Pub. Date: Jun. 26, 2025

(54) IMAGE FORMING APPARATUS

(71) Applicant: FUJIFILM Business Innovation Corp., Tokyo (JP)

(72) Inventors: Yuki NAGAMORI, Kanagawa (JP); Hirotaka TANAKA, Kanagawa (JP); Tsutomu SUGIMOTO, Kanagawa (JP)

(73) Assignee: FUJIFILM Business Innovation Corp., Tokyo (JP)

(21) Appl. No.: 18/741,797

(22) Filed: Jun. 13, 2024

(30) Foreign Application Priority Data
Dec. 25, 2023 (JP) 2023-218573

(51) Int. Cl. G03G 15/00

(52) U.S. Cl. CPC G03G 15/5008; G03G 15/5004; G03G 15/505; G03G 2215/1623

(57) ABSTRACT

An image forming apparatus includes a photoreceptor that holds a toner image to be transferred to a paper sheet, a charger that charges a surface of the photoreceptor, a developer that supplies toner to the surface of the photoreceptor, a cleaning unit that collects toner stuck to the photoreceptor, and a unit that changes a positional relationship between the photoreceptor and the charger and/or a positional relationship between the photoreceptor and the cleaning unit under a predetermined condition after the photoreceptor stops.

### CROSS-REFERENCE TO RELATED APPLICATIONS

This application is based on and claims priority under 35 USC 119 from Japanese Patent Application No. 2023-218573 filed Dec. 25, 2023.

### BACKGROUND

### (i) Technical Field

The present invention relates to an image forming apparatus.

### (ii) Related Art

JP2023-70972A addresses an issue of reducing occurrence of an abnormal image such as a blurred image or a scratchy image. In order to address the issue, a technology for executing a control mode for idly driving a photoreceptor before a start of a printing operation in a case where a time exceeding a predetermined time elapses after a previous printing operation is finished has been disclosed.

### SUMMARY

For example, a photoreceptor used in an image forming apparatus waits in a stopped state after printing is finished, before a subsequent printing instruction is provided. In the stopped state, for example, a positional relationship between the photoreceptor and a cleaning unit that collects toner stuck to a surface of the photoreceptor is fixed. In this case, a component volatilized from waste toner of the cleaning unit may be absorbed into the surface of the photoreceptor. The component volatilized from the waste toner increases a residual potential on the surface of the photoreceptor. Accordingly, an abnormal image may occur. In addition, for example, in a case where a positional relationship between a charger and the photoreceptor is fixed, a discharge product of the charger sticks to the surface of the photoreceptor, and the discharge product dissolves in water adsorbed on the surface at high humidity to decrease electrical resistance. Accordingly, an abnormal image may occur.

Aspects of non-limiting embodiments of the present disclosure relate to an image forming apparatus that suppresses occurrence of an abnormal image, compared to a case where a positional relationship between a photoreceptor and a charger and/or a cleaning unit does not change before printing is started.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a photoreceptor that holds a toner image to be transferred to a paper sheet, a charger that charges a surface of the photoreceptor, a developer that supplies toner to the surface of the photoreceptor, a cleaning unit that collects toner stuck to the photoreceptor, and a unit that changes a positional relationship between the photoreceptor and the charger and/or a positional relationship between the photoreceptor and the cleaning unit under a predetermined condition after the photoreceptor stops.

### BRIEF DESCRIPTION OF THE DRAWINGS

Exemplary embodiment(s) of the present invention will be described in detail based on the following figures, wherein:

FIG. 1 is a diagram for describing an image forming apparatus in the present exemplary embodiment;

FIG. 2 is an enlarged view of an image forming unit;

FIG. 3 is a timing chart in each mode in a case where a rotation control of a photoreceptor in the present exemplary embodiment is performed;

FIG. 4 is a flowchart of the rotation control of the photoreceptor in a normal mode in the present exemplary embodiment; and

FIG. 5 is a flowchart of the rotation control of the photoreceptor in a power saving mode in the present exemplary embodiment.

### DETAILED DESCRIPTION

Hereinafter, an exemplary embodiment of the present invention will be described in detail with reference to the accompanying drawings.

### Description of Image Forming Apparatus

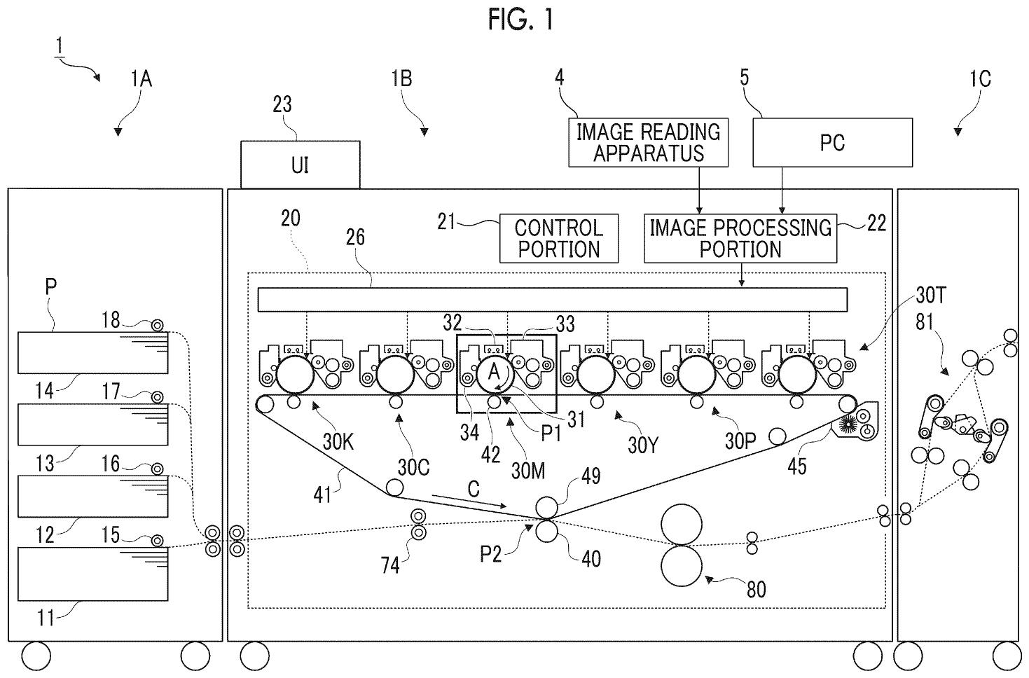

FIG. 1 is a diagram for describing an image forming apparatus 1 in the present exemplary embodiment.

The image forming apparatus 1 according to the present exemplary embodiment includes a paper feeding unit 1A, a printing unit 1B, and a paper discharging unit 1C.

The paper feeding unit 1A includes a first paper sheet accommodation portion 11 to a fourth paper sheet accommodation portion 14 that accommodate a paper sheet P as an example of a recording medium.

In addition, feeding rolls 15 to 18 that are provided to correspond to the first paper sheet accommodation portion 11 to the fourth paper sheet accommodation portion 14, respectively, and that feed the paper sheet P accommodated in each paper sheet accommodation portion to a transport path connected to the printing unit 1B are provided in the paper feeding unit 1A.

The printing unit 1B includes an image forming portion 20 that forms an image on the paper sheet P. In addition, a control portion 21 that controls each part of the image forming apparatus 1 is provided in the printing unit 1B.

In addition, the printing unit 1B includes an image processing portion 22. The image processing portion 22 performs image processing on image data transmitted from an image reading apparatus 4 or from a personal computer (PC) 5.

In addition, a user interface (UI) 23 that is configured with a touch panel or the like and that notifies a user of information and receives input of information from the user is provided in the printing unit 1B.

Six image forming units 30T, 30P, 30Y, 30M, 30C, and 30K (hereinafter, may be simply referred to as “image forming units 30”) disposed parallel to each other at constant intervals are provided in the image forming portion 20.

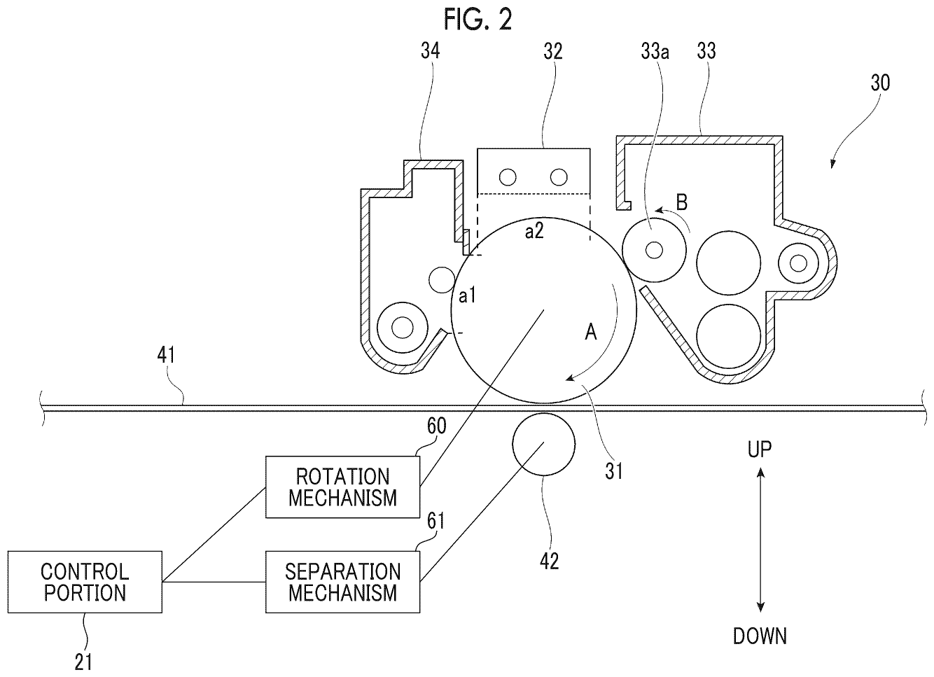

Each image forming unit 30 includes a photoreceptor 31 that holds a toner image to be transferred to the paper sheet P, a charger 32 that charges a surface of the photoreceptor 31, a developer 33 that develops an electrostatic latent image formed on the photoreceptor 31 and that supplies toner to the surface of the photoreceptor 31, and a cleaning unit 34 that removes and collects toner or the like on the surface of the photoreceptor 31 as waste toner. The photoreceptor 31 is rotated in a direction of arrow A by a rotation mechanism 60 (refer to FIG. 2), described later. While a so-called scorotron used in a contactless system is illustrated in FIG. 1 as the charger 32, a so-called charge roller used in a contact system may also be used.

In addition, an exposure device 26 that exposes the photoreceptor 31 of each image forming unit 30 to laser light is provided in the image forming portion 20.

The exposure of the photoreceptor 31 by the exposure device 26 is not limited to use of laser light. For example, a light source such as a light emitting diode (LED) may be provided for each image forming unit 30, and the exposure of the photoreceptor 31 may be performed using light emitted from the light source.

Each image forming unit 30 has the same configuration except for the toner accommodated in the developer 33. The image forming units 30Y, 30M, 30C, and 30K form toner images of yellow (Y), magenta (M), cyan (C), and black (K), respectively.

In addition, the image forming units 30T and 30P form toner images using white toner, toner corresponding to a corporate color, formable toner for braille, fluorescent color toner, toner that improves glossiness, and the like. In other words, the image forming units 30T and 30P form toner images using toner of special colors.

In addition, an intermediate transfer belt 41 to which the toner image of each color formed on the photoreceptor 31 of each image forming unit 30 is transferred is provided in the image forming portion 20. The intermediate transfer belt 41 is an example of a transfer belt.

In addition, a primary transfer roll 42 that causes each color toner image of each image forming unit 30 to be transferred to the intermediate transfer belt 41 in a primary transfer portion P1 is provided in the image forming portion 20.

In addition, a secondary transfer roll 40 that causes the toner images transferred on the intermediate transfer belt 41 to be transferred to the paper sheet P at once in a secondary transfer portion P2 is provided in the image forming portion 20.

Furthermore, a belt cleaner 45 that removes toner or the like on a surface of the intermediate transfer belt 41, and a fixer 80 that fixes the secondarily transferred image on the paper sheet P are provided in the image forming portion 20.

The image forming portion 20 performs an image forming operation based on a control signal from the control portion 21.

Specifically, in the image forming portion 20, the image processing portion 22 performs the image processing on the image data input from the image reading apparatus 4 or from the PC 5, and the image data after the image processing is performed is supplied to the exposure device 26.

For example, in the image forming unit 30M of magenta (M), the charger 32 charges the surface of the photoreceptor 31, and then the exposure device 26 irradiates the photoreceptor 31 with laser light that is modulated using the image data obtained from the image processing portion 22. Accordingly, an electrostatic latent image is formed on the photoreceptor 31.

The formed electrostatic latent image is developed by the developer 33, and a toner image of magenta is formed on the photoreceptor 31.

Similarly, toner images of yellow, cyan, and black are formed in the image forming units 30Y, 30C, and 30K, and toner images of special colors are formed in the image forming units 30T and 30P.

Each color toner image formed in each image forming unit 30 is sequentially electrostatically transferred to the intermediate transfer belt 41 rotating in a direction of arrow C in FIG. 1 by the primary transfer roll 42, and superimposed toner images are formed on the intermediate transfer belt 41.

The superimposed toner images formed on the intermediate transfer belt 41 are transported to the secondary transfer portion P2 configured with the secondary transfer roll 40 and a backup roll 49 in accordance with movement of the intermediate transfer belt 41.

Meanwhile, for example, the paper sheet P is taken from the first paper sheet accommodation portion 11 by the feeding roll 15 and is then transported to a position of a resist roll 74 through the transport path.

In a case where the superimposed toner images are transported to the secondary transfer portion P2, the paper sheet P is supplied to the secondary transfer portion P2 from the resist roll 74 in accordance with a time of the transport.

In the secondary transfer portion P2, the superimposed toner images are electrostatically transferred to the paper sheet P at once by an effect of a transfer electric field formed between the secondary transfer roll 40 and the backup roll 49.

Then, the paper sheet P on which the superimposed toner images are electrostatically transferred is transported to the fixer 80.

In the fixer 80, fixing processing of the toner image to the paper sheet P is performed by pressurizing and heating the paper sheet P on which a non-fixed toner image is formed, under control of the control portion 21.

The paper sheet P on which the fixing processing is performed passes through a curl correction portion 81 provided in the paper discharging unit 1C and is then transported to a paper sheet stacking portion (not illustrated).

### Description of Each Mechanism Controlled by Control Portion 21

FIG. 2 is an enlarged view of the image forming unit 30. The rotation mechanism 60 and a separation mechanism 61 in the present exemplary embodiment will be described using FIG. 2. The rotation mechanism 60 and the separation mechanism 61 are controlled by the control portion 21 described in FIG. 1.

First, the rotation mechanism 60 will be described. The image forming apparatus 1 includes the rotation mechanism 60 that rotates the photoreceptor 31. A case where the rotation mechanism 60 rotates the photoreceptor 31 in the direction of A in FIG. 2 includes a case where the image forming apparatus 1 described in FIG. 1 performs the image forming operation, and a case where the image forming apparatus 1 performs the image forming operation under a predetermined condition after the rotation of the photoreceptor 31 stops. Examples of the predetermined condition include an elapse of a predetermined time after the photoreceptor stops. Here, the predetermined time is, for example, a time determined for suppressing a change in the photoreceptor 31 caused by a volatile component from the waste toner in the cleaning unit 34 and is, for example, two hours. In addition, another example of the predetermined time is, for example, a time determined for suppressing a change in the photoreceptor 31 caused by discharge from the charger 32 and is, for example, five hours.

The predetermined time changes depending on situations of the photoreceptor 31, the cleaning unit 34, the charger 32, and the like. The rotation mechanism 60 rotates the photoreceptor 31 in order to suppress the change in the photoreceptor 31 caused by the volatile component from the waste toner in the cleaning unit 34 or to suppress the change in the photoreceptor 31 caused by the discharge from the charger 32. In addition, depending on a case, the photoreceptor 31 is rotated for a predetermined time under both conditions for suppressing the changes. That is, a positional relationship between the photoreceptor 31 and the charger 32 and/or a positional relationship between the photoreceptor 31 and the cleaning unit 34 is changed under the predetermined condition after the photoreceptor 31 stops.

The change in the photoreceptor 31 caused by the volatile component from the waste toner in the cleaning unit 34 may be referred to as a cleaning unit-derived defect. In addition, the change in the photoreceptor 31 caused by the discharge from the charger 32 may be referred to as a charger-derived defect.

In a case where the image forming apparatus 1 performs the image forming operation, the rotation mechanism 60 rotates the photoreceptor 31 one round in the direction of A. Meanwhile, in a case where the predetermined time has elapsed after the photoreceptor 31 stops, the rotation mechanism 60 rotates the photoreceptor 31 by a predetermined distance or longer. Rotating the photoreceptor 31 by the predetermined distance or longer changes the positional relationship between the photoreceptor 31 and the cleaning unit 34 and the positional relationship between the photoreceptor 31 and the charger 32. The predetermined distance is, for example, a distance of an arc of a region a1 surrounded by the cleaning unit 34 in a region of the surface of the photoreceptor 31. In addition, the predetermined distance is, for example, a distance of an arc of a region a2 surrounded by the charger 32 in the region of the surface of the photoreceptor 31. That is, the rotation mechanism 60 rotates the photoreceptor 31 by the distance of the arc of the region a1 or longer or by the distance of the arc of the region a2 or longer.

At this point, the region a1 after movement is moved to a region that does not overlap with the region a1 before movement. Furthermore, the region surrounded by the cleaning unit 34 is changed to a region different from the region a1.

In addition, at this point, the region a2 after movement is moved to a region that does not overlap with the region a2 before movement. Furthermore, the region surrounded by the charger 32 is changed to a region different from the region a2.

The photoreceptor 31 may be rotated in a direction opposite to the direction of A in order to change a positional relationship between the cleaning unit 34 and the charger 32, and the region a1 and the region a2. In addition, the cleaning unit 34 may be moved instead of moving the photoreceptor 31.

In the present exemplary embodiment, the cleaning unit-derived defect and/or the charger-derived defect is eliminated by changing the predetermined time and the predetermined distance depending on various situations such as a difference in a type or a structure and a difference in a relationship among the cleaning unit 34, the charger 32, and the photoreceptor 31. In a case of eliminating any one of the cleaning unit-derived defect and the charger-derived defect, the predetermined condition is set to eliminate each defect after the photoreceptor 31 stops. As the predetermined condition, for example, the time determined for eliminating each defect is set as the predetermined time, and a distance longer than or equal to the distance of a length of the arc of each surrounded region is set as the predetermined distance. For example, in a case of eliminating the cleaning unit-derived defect, the time determined for eliminating the cleaning unit-derived defect is set as the predetermined time, and a distance longer than or equal to the distance of the arc of the region a1 surrounded by the cleaning unit 34 is set as the predetermined distance. In addition, for example, in a case of eliminating the charger-derived defect, the time determined for eliminating the charger-derived defect is set as the predetermined time, and a distance longer than or equal to the distance of the arc of the region a2 surrounded by the charger 32 is set as the predetermined distance.

In a case of eliminating both defects of the cleaning unit-derived defect and the charger-derived defect, the predetermined time and the predetermined distance are set by comparing lengths of the time determined for suppressing each derived defect and magnitudes of the length of the arc of each surrounded region. For example, a case where the time for suppressing the charger-derived defect is shorter than the time for suppressing the cleaning unit-derived defect and where the length of the arc of the region a2 surrounded by the charger 32 is longer than the length of the arc of the region a1 surrounded by the cleaning unit 34 is assumed.

That is, in a case of time for suppressing the cleaning unit-derived defect>time for suppressing the charger-derived defect and length of the arc of the region a1<length of the arc of the region a2, the time determined for suppressing the charger-derived defect is set as the predetermined time, and a distance longer than or equal to the distance of the arc of the region a2 surrounded by the charger 32 is set as the predetermined distance, in order to eliminate both of the cleaning unit-derived defect and the charger-derived defect.

In addition, for example, a case where the time for suppressing the charger-derived defect is longer than the time for suppressing the cleaning unit-derived defect and where the length of the arc of the region a2 surrounded by the charger 32 is longer than the length of the arc of the region a1 surrounded by the cleaning unit 34 is assumed. That is, a case of time for suppressing the cleaning unit-derived defect<time for suppressing the charger-derived defect and length of the arc of the region a1<length of the arc of the region a2 is assumed. Furthermore, an assumption that the region a2 after movement is moved to a region not overlapping with the region a2 before movement by moving the length of the arc of the region a1 n times is assumed. That is, a case where the length of the arc of the region a1 moved n times exceeds the length of the arc of the region a2 surrounded by the charger 32 is assumed. In this case, in order to eliminate both of the cleaning unit-derived defect and the charger-derived defect, the predetermined time is set on a condition that a time required for movement performed once is shorter than or equal to the time determined for suppressing the cleaning unit-derived defect and that a time required for performing movement n times is shorter than or equal to the time determined for suppressing the charger-derived defect. Furthermore, the predetermined distance is set on a condition of a distance longer than or equal to the distance of the arc of the region a1 surrounded by the cleaning unit 34.

The predetermined time can also be set on a condition of the time determined for suppressing the cleaning unit-derived defect, and the predetermined distance can also be set on a condition of a distance longer than or equal to the distance of the arc of the region a2 surrounded by the charger 32, without taking into consideration the movement of the length of the arc of the region a1 performed n times.

While a relationship between the photoreceptor 31 and the cleaning unit 34 and/or the charger 32 has been described, occurrence of an abnormal image may be suppressed by changing a positional relationship between the photoreceptor 31 and the developer 33.

More specifically, the positional relationship between the photoreceptor 31 and the developer 33 is changed by rotating the photoreceptor 31 by the predetermined distance via the rotation mechanism 60 after the predetermined time elapses from the stoppage of the photoreceptor 31. In this case, the predetermined time is a time determined for suppressing a change in the photoreceptor caused by a volatile component from the toner in the developer 33. In addition, the predetermined distance corresponds to a region surrounded by the developer 33 in the region of the surface of the photoreceptor 31. In addition, the developer 33 may be additionally taken into consideration in setting the predetermined time and the predetermined distance as described above. The developer 33 includes a developing roll 33a that is in contact with the photoreceptor 31. The rotation mechanism 60 also rotates the developing roll 33a in a direction of arrow B in rotating the photoreceptor 31. Accordingly, friction between the developer 33 and the photoreceptor 31 may be reduced.

Next, the separation mechanism 61 will be described. The image forming apparatus 1 includes the separation mechanism 61 that adjusts a state of contact between the intermediate transfer belt 41 and the photoreceptor 31. For example, the separation mechanism 61 brings the intermediate transfer belt 41 into contact with the photoreceptor 31 by pushing the primary transfer roll 42 and releases the contact between the intermediate transfer belt 41 and the photoreceptor 31 by pulling the primary transfer roll 42. That is, the separation mechanism 61 moves the intermediate transfer belt 41 to a position separated from the photoreceptor 31. The separation mechanism 61 is configured by combining a motor, a solenoid, a spring structure, and the like.

### Rotation Control of Photoreceptor 31 in Each Mode

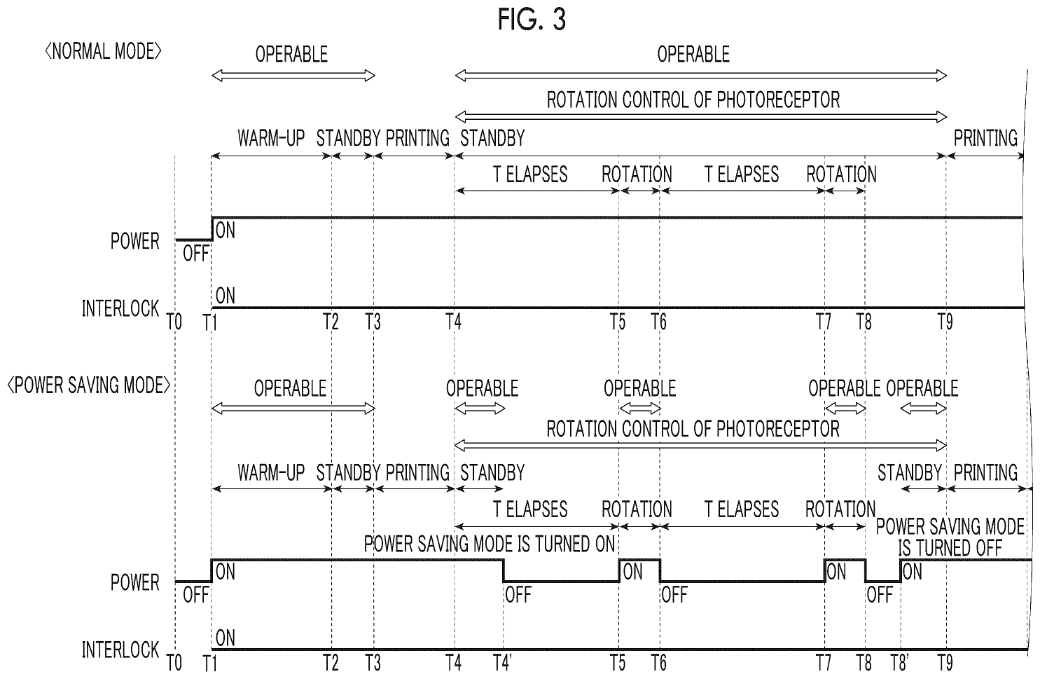

Next, a flow of a rotation control of the photoreceptor 31 in each mode in the present exemplary embodiment will be described using FIGS. 3 to 5.

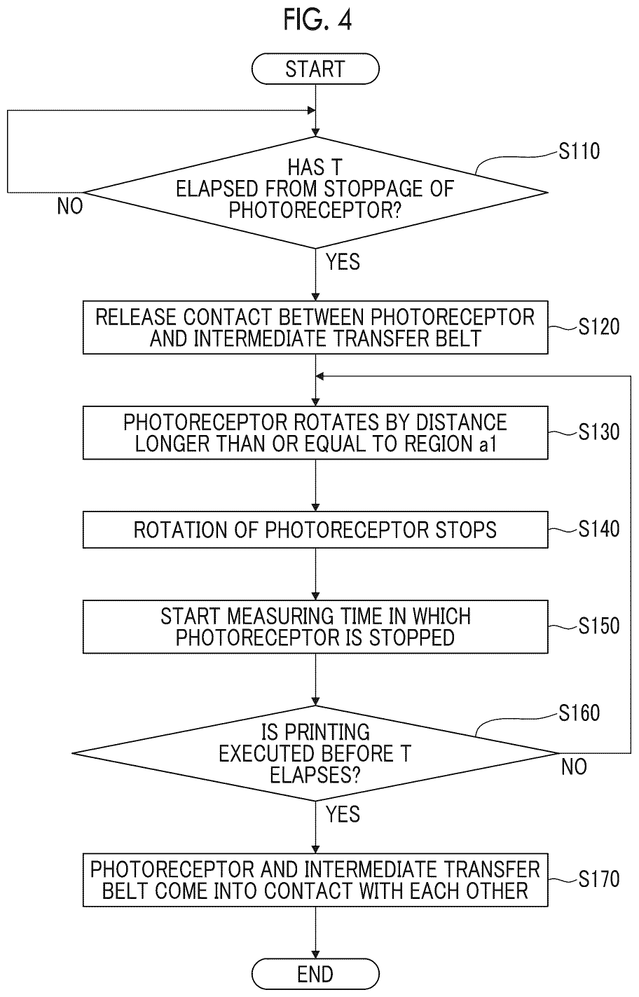

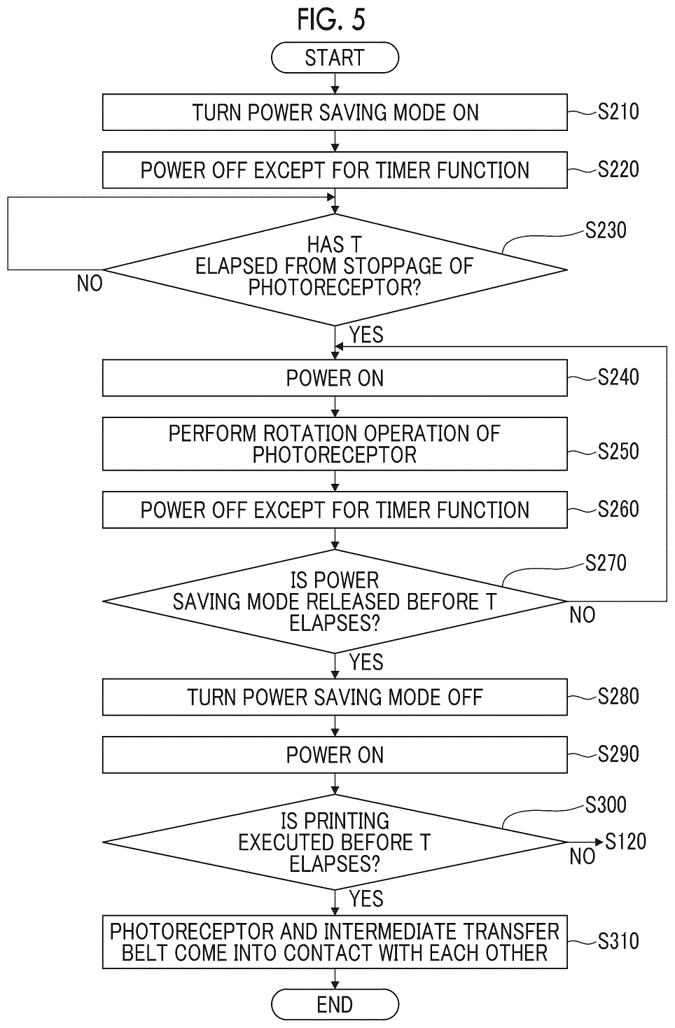

FIG. 3 is a timing chart illustrating the rotation control of the photoreceptor 31. Here, two modes are illustrated. In FIG. 3, an upper part illustrates the rotation control of the photoreceptor 31 in a “normal mode”, and a lower part illustrates the rotation control of the photoreceptor 31 in a “power saving mode”. T0 to T9 illustrated in FIG. 3 indicate time points for description. In addition, FIG. 4 is a flowchart of the rotation control of the photoreceptor 31 in the normal mode in the present exemplary embodiment, and FIG. 5 is a flowchart of the rotation control of the photoreceptor 31 in the power saving mode in the present exemplary embodiment. Here, the power saving mode is a mode in which power consumption of the image forming apparatus 1 is reduced below power consumption of the image forming apparatus 1 in a normal standby state. Examples of the power saving mode include a state where the image forming apparatus 1 is powered OFF except for a timer function. The normal mode is, for example, a state where the image forming apparatus 1 is powered ON, including the normal standby state.

The rotation control of the photoreceptor 31 as a section that suppresses the cleaning unit-derived defect is described in FIGS. 3 to 5. Thus, a predetermined time T is the time determined for suppressing the cleaning unit-derived defect, and the predetermined distance corresponds to the region a1 surrounded by the cleaning unit 34. However, as described above, the predetermined time and the predetermined distance are set in accordance with the situations of the cleaning unit 34, the charger 32, and the photoreceptor 31. The predetermined time T may be simply referred to as T.

### Rotation Control of Photoreceptor 31 in Normal Mode

First, the rotation control of the photoreceptor 31 in the normal mode for suppressing the occurrence of the abnormal image will be described using FIGS. 3 and 4.

First, <normal mode> illustrated in the upper part of FIG. 3 will be described. First, the image forming apparatus 1 that is powered OFF at T0 is powered ON at T1, and the image forming apparatus 1 transitions to the normal mode. Powering ON enables detection of an interlock. The interlock is turned ON in a state where a front cover (not illustrated) of the image forming apparatus 1 is closed. Powering ON causes the image forming apparatus 1 to transition to a warm-up state. The warm-up state is a period in which the image forming apparatus 1 prepares for printing.

Next, at T2 in FIG. 3, the image forming apparatus 1 transitions to the standby state from the warm-up state. The standby state is, for example, a period in which the image forming apparatus 1 waits for printing before starting to form an image in accordance with an instruction from an external apparatus. Next, at T3 in FIG. 3, for example, the image forming apparatus 1 starts printing in accordance with the instruction from the external apparatus, and the image forming apparatus 1 transitions to a printing state from the standby state. The printing state is a period in which the image forming apparatus 1 performs printing. The photoreceptor 31 rotates one round in this period. Next, at T4 in FIG. 3, the printing of the image forming apparatus 1 is finished. Here, for convenience, the one round rotation of the photoreceptor 31 is assumed to stop in accordance with the finish of the printing of the image forming apparatus 1. At T4, the image forming apparatus 1 transitions to the standby state again from the printing state. A time in which the photoreceptor 31 is stopped is measured from T4.

The time in which the photoreceptor 31 is stopped is measured from T4 in FIG. 3. In a case where the predetermined time T elapses (T5 in FIG. 3), the photoreceptor 31 rotates. In a case where the photoreceptor 31 rotates by the predetermined distance, the photoreceptor 31 stops (T6 in FIG. 3). Similarly, a time in which the photoreceptor 31 is stopped is measured from T6 in FIG. 3. In a case where the predetermined time T elapses (T7 in FIG. 3), the photoreceptor 31 rotates. In a case where the photoreceptor 31 rotates by the predetermined distance, the photoreceptor 31 stops (T8 in FIG. 3). The rotation control of the photoreceptor 31 for suppressing the occurrence of the abnormal image is repeated in the standby state before the printing of the image forming apparatus 1 is started. For example, in a case where the printing of the image forming apparatus 1 starts in accordance with the instruction from the external apparatus (T9 in FIG. 3), the image forming apparatus 1 transitions to the printing state from the standby state.

Next, the rotation control of the photoreceptor 31 in the normal mode for suppressing the occurrence of the abnormal image will be described using the flowchart illustrated in FIG. 4. In the rotation control of the photoreceptor 31 in the normal mode, in a case where the time in which the photoreceptor 31 is stopped has elapsed over the predetermined time T from the stoppage of the photoreceptor 31 (YES in S110), the separation mechanism 61 described in FIG. 2 releases the contact between the photoreceptor 31 and the intermediate transfer belt 41 (S120). In a case where the predetermined time T has not elapsed from the stoppage of the photoreceptor 31 (NO in S110), the time in which the photoreceptor 31 is stopped is measured again. In a case where the contact between the photoreceptor 31 and the intermediate transfer belt 41 is released, the rotation mechanism 60 described in FIG. 2 rotates the photoreceptor 31 by a distance longer than or equal to the region a1 (S130). In a case where the rotation of the photoreceptor 31 stops (S140), the time in which the photoreceptor 31 is stopped is measured again (S150). Then, in a case where printing is not executed before the predetermined time T elapses from the stoppage of the photoreceptor 31 (NO in S160), steps S130 to S150 are executed again. In a case where printing is executed before the predetermined time T elapses from the stoppage of the photoreceptor 31 (YES in S160), the separation mechanism 61 described in FIG. 2 brings the photoreceptor 31 and the intermediate transfer belt 41 into contact with each other (S170), and the rotation control of the photoreceptor 31 for suppressing the occurrence of the abnormal image is finished.

The contact (S170) between the photoreceptor 31 and the intermediate transfer belt 41 may be made at a timing between S150 and S160. In this case, in a case where printing is not executed before the predetermined time T elapses (NO in S160), steps S120 to S150 and S170 are executed again. In a case where printing is executed before the predetermined time T elapses (YES in S160), the rotation control of the photoreceptor 31 is finished because the contact between the photoreceptor 31 and the intermediate transfer belt 41 has already been made.

In addition, while a rotation speed of the photoreceptor 31 in the rotation control of the photoreceptor 31 for suppressing the occurrence of the abnormal image can be equal to a rotation speed in the printing state or any rotation speed, the rotation speed may also be set to be slower than the rotation speed of the photoreceptor 31 in the printing state. By setting the rotation speed to be slower than the rotation speed of the photoreceptor 31 in the printing state, an adverse effect caused by increasing the rotation speed of the photoreceptor 31 is suppressed. For example, the rotation speed in performing the rotation control for suppressing the occurrence of the abnormal image is set to 1/6 of the rotation speed in the printing state.

The rotation control of the photoreceptor 31 for suppressing the occurrence of the abnormal image changes the positional relationship between the cleaning unit 34 and the photoreceptor 31 or the positional relationship between the charger 32 and the photoreceptor 31 under the predetermined condition. Therefore, the rotation control of the photoreceptor 31 functions as one of suppressing units that suppress an increase in a residual potential on the surface of the photoreceptor 31 or a decrease in electrical resistance caused by sticking of a discharge product of the charger 32 to the surface of the photoreceptor 31 after the photoreceptor 31 stops.

### Rotation Control of Photoreceptor 31 in Power Saving Mode

Next, the rotation control of the photoreceptor 31 in the power saving mode for suppressing the occurrence of the abnormal image will be described using <power saving mode> illustrated in the lower part of FIG. 3.

First, the image forming apparatus 1 that is powered OFF at T0 is powered ON at T1. Powering ON causes the image forming apparatus 1 to transition to the warm-up state. The warm-up state is a period in which the image forming apparatus 1 prepares for printing.

Next, at T2 in FIG. 3, the image forming apparatus 1 transitions to the standby state from the warm-up state. At T3 in FIG. 3, for example, the image forming apparatus 1 starts printing in accordance with the instruction from the external apparatus, and the image forming apparatus 1 transitions to the printing state from the standby state. At T4 in FIG. 3, the printing of the image forming apparatus 1 is finished. At T4, the image forming apparatus 1 transitions to the standby state again from the printing state. A time in which the photoreceptor 31 is stopped is measured from T4.

Next, in a case where the power saving mode is turned ON, the image forming apparatus 1 transitions to the power saving mode (T4′ in FIG. 3). The power saving mode is turned ON by, for example, a selection of the user from the UI 23 illustrated in FIG. 1. The image forming apparatus 1 is powered OFF except for the timer function in accordance with the transition to the power saving mode. The time in which the photoreceptor 31 is stopped is measured from T4 in FIG. 3. In a case where the predetermined time T has elapsed (T5 in FIG. 3), the image forming apparatus 1 is powered ON, and the photoreceptor 31 rotates. In a case where the photoreceptor 31 rotates by the predetermined distance, the photoreceptor 31 stops, and the image forming apparatus 1 is powered OFF (T6 in FIG. 3). Similarly, a time in which the photoreceptor 31 is stopped is measured from T6 in FIG. 3. In a case where the predetermined time T has elapsed (T7 in FIG. 3), the image forming apparatus 1 is powered ON, and the photoreceptor 31 rotates. In a case where the photoreceptor 31 rotates by the predetermined distance, the photoreceptor 31 stops, and the image forming apparatus 1 is powered OFF (T8 in FIG. 3). The rotation control of the photoreceptor 31 for suppressing the occurrence of the abnormal image is repeated until the power saving mode of the image forming apparatus 1 is released. While the power saving mode is released by starting printing, the power saving mode can be turned OFF by, for example, a selection of the user from the UI 23 illustrated in FIG. 1. Here, after the power saving mode of the image forming apparatus 1 is released (T8′ in FIG. 3), the printing of the image forming apparatus 1 is started by receiving a printing instruction (T9 in FIG. 3).

Next, the rotation control of the photoreceptor 31 in the power saving mode for suppressing the occurrence of the abnormal image will be described using the flowchart illustrated in FIG. 5. First, in a case where the power saving mode is turned ON (S210), the image forming apparatus 1 is powered OFF except for the timer function (S220). In a case where the time in which the photoreceptor 31 is stopped has elapsed over the predetermined time T from the stoppage of the photoreceptor 31 (YES in S230), the image forming apparatus 1 is powered ON (S240). In a case where the predetermined time T has not elapsed from the stoppage of the photoreceptor 31 (NO in S230), the time in which the photoreceptor 31 is stopped is measured again. After the image forming apparatus 1 is powered ON, the control portion performs a rotation operation of the photoreceptor 31 (S250). Specifically, steps S120 to S150 illustrated in FIG. 4 are performed. Step S170 may be performed after steps S120 to S150.

In a case where the rotation operation of the photoreceptor 31 by the control portion is finished, the image forming apparatus 1 is powered OFF except for the timer function (S260 in FIG. 5). Next, in a case where the power saving mode is not released before the predetermined time T elapses from the stoppage of the photoreceptor 31 (NO in S270), steps S240 to S260 in FIG. 5 are executed again. Next, in a case where the power saving mode is released before the predetermined time T elapses from the stoppage of the photoreceptor 31 (YES in S270), the power saving mode is turned OFF (S280). The image forming apparatus 1 is powered ON in accordance with turning OFF of the power saving mode (S290). At this point, the measurement of the time in which the photoreceptor 31 is stopped continues.

Next, in a case where printing is executed before the predetermined time T elapses from the stoppage of the photoreceptor 31 (YES in S300), the separation mechanism 61 described in FIG. 2 brings the photoreceptor 31 and the intermediate transfer belt 41 into contact with each other (S310), and the rotation control of the photoreceptor 31 for suppressing the occurrence of the abnormal image is finished. In a case where printing is not executed before the elapse of the predetermined time T even after the power saving mode is released (NO in S300), the rotation control of the photoreceptor 31 in the normal mode for suppressing the occurrence of the abnormal image is performed. Specifically, steps S120 to S170 in FIG. 4 are performed.

While the photoreceptor 31 is rotated after the elapse of the predetermined time T in the present exemplary embodiment, the rotation of the photoreceptor 31 is not limited to the predetermined time T and may be gradually performed. For example, an aspect of rotating the photoreceptor 31 little by little at short time intervals is possible. A total sum of distances in which movement is performed little by little at the short time intervals is designed to satisfy the above “predetermined condition” for suppressing the cleaning unit-derived defect and the charger-derived defect.

### Supplementary Note

(((1)))

An image forming apparatus comprising:
a photoreceptor that holds a toner image to be transferred to a paper sheet;
a charger that charges a surface of the photoreceptor;
a developer that supplies toner to the surface of the photoreceptor;
a cleaning unit that collects toner stuck to the photoreceptor; and
a unit that changes a positional relationship between the photoreceptor and the charger and/or a positional relationship between the photoreceptor and the cleaning unit under a predetermined condition after the photoreceptor stops.
   (((2)))

The image forming apparatus according to (((1))
wherein the unit that changes the positional relationship moves the photoreceptor by a predetermined distance on a condition that a predetermined time has elapsed after the photoreceptor stops.
   (((3)))

The image forming apparatus according to (((1))) or (((2))),
wherein the unit that changes the positional relationship rotates the photoreceptor at a speed slower than a speed in a printing state.
   (((4)))

The image forming apparatus according to any one of (((1))) to (((3)),
wherein the unit that changes the positional relationship rotates the photoreceptor and also rotates the developer.
   (((5)))

The image forming apparatus according to any one of (((1))) to (((4))), further comprising:
a transfer belt to which the toner image held in the photoreceptor is transferred,
wherein in moving the photoreceptor by a predetermined distance, the transfer belt is moved to a position separated from the photoreceptor.
   (((6)))

The image forming apparatus according to (((1))),
wherein the unit that changes the positional relationship transitions to a mode for suppressing power consumption after the photoreceptor stops, and changes the positional relationship between the photoreceptor and the charger and/or the positional relationship between the cleaning unit and the photoreceptor under the predetermined condition.
   (((7)))

The image forming apparatus according to (((6))),
wherein the predetermined condition is a condition determined for suppressing a change in the photoreceptor caused by discharge from the charger and/or a change in the photoreceptor caused by a volatile component from waste toner in the cleaning unit.
   (((8)))

An image forming apparatus comprising:
a photoreceptor that holds a toner image to be transferred to a paper sheet;
a charger that charges a surface of the photoreceptor;
a developer that supplies toner to the surface of the photoreceptor;
a cleaning unit that collects toner stuck to the photoreceptor; and
a suppressing unit that suppresses an increase in a residual potential on the surface of the photoreceptor or a decrease in electrical resistance caused by sticking of a discharge product of the charger to the surface of the photoreceptor after the photoreceptor stops.
   (((9)))

The image forming apparatus according to (((8))),
wherein the suppressing unit rotates the photoreceptor under a predetermined condition after the photoreceptor stops.
   (((10)))

The image forming apparatus according to (((9))),
wherein the predetermined condition is gradual rotation of the photoreceptor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a photoreceptor that holds a toner image to be transferred to a paper sheet;
a charger that charges a surface of the photoreceptor;
a developer that supplies toner to the surface of the photoreceptor;
a cleaning unit that collects toner stuck to the photoreceptor; and
a unit that changes a positional relationship between the photoreceptor and the charger and/or a positional relationship between the photoreceptor and the cleaning unit under a predetermined condition after the photoreceptor stops.

2. The image forming apparatus according to claim 1,
wherein the unit that changes the positional relationship moves the photoreceptor by a predetermined distance on a condition that a predetermined time has elapsed after the photoreceptor stops.

3. The image forming apparatus according to claim 2,
wherein the unit that changes the positional relationship rotates the photoreceptor at a speed slower than a speed in a printing state.

4. The image forming apparatus according to claim 2,
wherein the unit that changes the positional relationship rotates the photoreceptor and also rotates the developer.

5. The image forming apparatus according to claim 2, further comprising:
a transfer belt to which the toner image held in the photoreceptor is transferred,
wherein in moving the photoreceptor by a predetermined distance, the transfer belt is moved to a position separated from the photoreceptor.

6. The image forming apparatus according to claim 1,
wherein the unit that changes the positional relationship transitions to a mode for suppressing power consumption after the photoreceptor stops, and changes the positional relationship between the photoreceptor and the charger and/or the positional relationship between the cleaning unit and the photoreceptor under the predetermined condition.

7. The image forming apparatus according to claim 6,
wherein the predetermined condition is a condition determined for suppressing a change in the photoreceptor caused by discharge from the charger and/or a change in the photoreceptor caused by a volatile component from waste toner in the cleaning unit.

8. An image forming apparatus comprising:
a photoreceptor that holds a toner image to be transferred to a paper sheet;
a charger that charges a surface of the photoreceptor;
a developer that supplies toner to the surface of the photoreceptor;
a cleaning unit that collects toner stuck to the photoreceptor; and
a suppressing unit that suppresses an increase in a residual potential on the surface of the photoreceptor or a decrease in electrical resistance caused by sticking of a discharge product of the charger to the surface of the photoreceptor after the photoreceptor stops.

9. The image forming apparatus according to claim 8,
wherein the suppressing unit rotates the photoreceptor under a predetermined condition after the photoreceptor stops.

10. The image forming apparatus according to claim 9,
wherein the predetermined condition is gradual rotation of the photoreceptor.

11. An image forming apparatus comprising:
a photoreceptor that holds a toner image to be transferred to a paper sheet;
a charger that charges a surface of the photoreceptor;
a developer that supplies toner to the surface of the photoreceptor;
a cleaning unit that collects toner stuck to the photoreceptor; and
means for changing a positional relationship between the photoreceptor and the charger and/or a positional relationship between the photoreceptor and the cleaning unit under a predetermined condition after the photoreceptor stops.
